(19) United States
(12) Patent Application Publication
(10) Pub. No.: US 2023/0174813 A1
(43) Pub. Date: Jun. 8, 2023

(54) PRETREATMENT LIQUID AND IMAGE FORMING METHOD

(71) Applicant: KONICA MINOLTA, INC., Tokyo (JP)

(72) Inventors: Mai KATO, Tokyo (JP); Ken NITO, Tokyo (JP)

(73) Assignee: KONICA MINOLTA, INC., Tokyo (JP)

(21) Appl. No.: 17/972,877

(22) Filed: Oct. 25, 2022

(30) Foreign Application Priority Data
Dec. 2, 2021 (JP) 2021-196224

(51) Int. Cl. C09D 11/54; C09D 11/033; C09D 11/037; C09D 11/328; D06P 5/28; D06P 5/00; D06P 3/60

(52) U.S. Cl. CPC C09D 11/54; C09D 11/033; C09D 11/037; C09D 11/328; D06P 5/005; D06P 5/002; D06P 3/6033; D06P 1/16

(57) ABSTRACT

A pretreatment liquid for a fabric used for transfer textile printing, includes a solvent having an organic/inorganic value (I/O value) of 1.0 to 3.0, and has a surface tension of less than 38 mN/m at 25° C.

The entire disclosure of Japanese patent Application No. 2021-196224, filed on Dec. 2, 2021, is incorporated herein by reference in its entirety.

### BACKGROUND

### Technological Field

The present invention relates to a pretreatment liquid and an image forming method.

### Description of the Related Art

As a textile printing method using an ink containing a dye, a method for transferring an ink layer containing a disperse dye, formed on a transfer medium to perform dyeing (sublimation transfer textile printing method) is known.

Since the disperse dye generally exhibits hydrophobicity, the disperse dye is easily fixed to a fabric containing a hydrophobic fiber such as a polyester fiber, and easily dyes the fabric. However, since a polarity difference between the disperse dye and a fabric containing a hydrophilic fiber such as a natural fiber is large, permeation of the disperse dye into the fabric or fixability of the disperse dye to the fabric is not sufficient, and it is difficult for the disperse dye to dye the fabric. Therefore, studies have been made in order to make it easy for the disperse dye to dye a fabric containing a hydrophilic fiber such as a natural fiber.

As such a method, there is known a transfer textile printing method in which a fabric is swollen with a swelling agent, then the fabric is subjected to transfer textile printing, and a synthetic resin liquid is applied to a surface of the dyed fabric (for example, JP H7-216763 A). As the swelling agent, an aqueous solution containing a polyhydric alcohol such as polypropylene glycol (I/O value: 3.3) is used.

In addition, there is known a transfer textile printing method in which a fabric is pretreated with a pretreatment liquid containing a swelling agent and a water repellent agent, then the fabric is subjected to transfer textile printing, and the dyed fabric is washed to remove the swelling agent (for example, JP 2021-42514 A). As the swelling agent, a polyhydric alcohol such as polypropylene glycol (I/O value: 3.3) is used.

In addition, there is known a transfer textile printing method in which a fabric is pretreated with a swelling agent, then the fabric is subjected to transfer textile printing, and the fabric is post-treated with a treatment agent containing a crosslinking agent and a catalyst (for example, JP S49-30686 A). As the swelling agent, a mixture of triethylene glycol (I/O value: 2.0) and ethylene glycol monoacetate (I/O value: 1.75) or the like is used.

However, even when the methods of JP H7-216763 A, JP 2021-42514 A, and JP S49-30686 A are applied to a fabric containing a hydrophilic fiber such as a natural fiber, a textile printed product having a sufficient color developing density and friction fastness could not be obtained.

Specifically, since the solvent contained in the pretreatment liquid of JP H7-216763 A and JP 2021-42514 A has low affinity with the disperse dye, it is difficult to obtain friction fastness. The pretreatment liquid in JP S49-30686 A has high surface tension and is unlikely to permeate a fiber of the fabric. Therefore, it is difficult for the disperse dye to enter a fiber of the pretreated fabric, and it is difficult to obtain a color developing density or friction fastness.

### SUMMARY

The present invention has been made in view of the above problems, and an object of the present invention is to provide a pretreatment liquid and an image forming method capable of forming an image having a high color developing density and friction fastness even on a fabric containing a hydrophilic fiber such as a natural fiber.

To achieve the abovementioned object, according to an aspect of the present invention, there is provided a pretreatment liquid for a fabric used for transfer textile printing, and the pretreatment liquid reflecting one aspect of the present invention comprises a solvent having an organic/inorganic value (I/O value) of 1.0 to 3.0, and has a surface tension of less than 38 mN/m at 25° C.

### DETAILED DESCRIPTION OF EMBODIMENTS

Hereinafter, one or more embodiments of the present invention will be described with reference to the drawings. However, the scope of the invention is not limited to the disclosed embodiments.

The present inventors have found that an image having a high color developing density and friction fastness can be formed even on a fabric containing a hydrophilic fiber such as a natural fiber by treating the fabric with a pretreatment liquid containing a solvent having an I/O value of 1.0 to 3.0 and having a surface tension of less than 35 mN/m.

This mechanism is not clear, but is presumed as follows. Since a solvent having an value of 1.0 to 3.0 has affinity with a hydrophilic fiber such as a natural fiber having an I/O value of around 3.0, the solvent easily swells the fiber. In addition, since the solvent having an I/O value of 1.0 to 3.0 has also affinity with a disperse dye having an I/O value of around 1.0, the solvent can also function as a carrier of the disperse dye in a fabric treated with a pretreatment liquid containing the solvent. By these actions, the disperse dye easily enters the fiber of the fabric, and therefore a color developing density can be enhanced. In addition, since the amount of the disperse dye remaining on a surface of the fiber without entering the fiber can be reduced, friction fastness can be enhanced.

Furthermore, by setting a surface tension of the pretreatment liquid to a certain value or less, the pretreatment liquid can more easily permeate the fiber, and the disperse dye can more easily enter the fiber. As a result, since the amount of the disperse dye remaining on the surface of the fiber can be further reduced, the color developing density and the friction fastness can be further enhanced.

In particular, the higher the swelling degree of the fiber (the closer the I/O value is to 3.0) and the higher the permeability of the pretreatment liquid (the lower the surface tension is), the higher the color developability tends to be. The higher the carrier property of the disperse dye in the pretreatment liquid (the closer the I/O value is to 1.0) and the higher the permeability (the lower the surface tension), the higher the friction fastness tends to be. Hereinafter, the components of the pretreatment liquid according to an embodiment of the present invention will be described in detail.

1. Pretreatment Liquid

The pretreatment liquid contains a solvent having an I/O value of 1.0 to 3.0.

1-1. Solvent

The “I/O value ”in the solvent having an I/O value of 1.0 to 3.0 is a ratio (inorganic value/organic value) of the inorganic value (I) to the organic value (O), and is one of indices indicating the magnitude of polarity. The closer the I/O value is to 0, the more nonpolar (hydrophobic) the solvent is. The larger the I/O value is, the more polar (hydrophilic) the solvent is.

As described above, the solvent having an I/O value of 1.0 to 3.0 has affinity with a natural fiber or a synthetic cellulose fiber (I/O value: about 3.0) constituting a fabric, and therefore easily swells these fibers. In a fabric treated with a pretreatment liquid containing such a solvent, the disperse dye easily enters the fiber. On the other hand, a solvent having an I/O value of 1.0 to 3.0 has also affinity with the disperse dye (I/O value: about 1.0), and therefore can function as a carrier of the disperse dye during transfer textile printing. As a result, the disperse dye can be easily moved from a surface to an inside of the fiber. As a result, it is possible to obtain an image-formed product having a high color developing density and excellent friction fastness. The I/O value of the solvent is more preferably 1.0 to 2.0, and still more preferably 1.0 to 1.8 from a similar viewpoint.

The I/O value can be calculated by the methods described in Organic conceptual diagram (written by Yoshio Koda, Sankyo Publishing (1984)); KUMAMOTO PHARMACEUTICAL BULLETIN, No. 1, Sections 1 to 16 (1954); and Chemical domain, Volume 11, No. 10, Sections 719 to 725 (1957). Specifically, an I value and an O value of the solvent are calculated front various functional groups (substituents or bonds) constituting a molecular structure of the solvent. Then, the I value is divided by the O value to obtain the I/O value. The molecular structure of the solvent can be identified by GCMS.

The I value of a substituent or a bond is obtained by quantifying an influence of the substituent or the bond on a boiling point based on a hydroxy group. Specifically, the I value of a substituent or a bond is obtained by defining an influence of one hydroxy group as a numerical value of 100, and quantifying an influence of the substituent or the bond on a boiling point based on this numerical value.

The O value of a substituent or a bond is determined based on an influence of a carbon atom representing a methylene group in a molecule on a boiling point by using the methylene group as a unit. Specifically, the O value of a substituent or a bond is obtained by defining the O value of one carbon atom as 20, and quantifying an influence of the substituent or the bond on a boiling point based on this numerical value.

The I value of the solvent represents a sum of I values of various substituents or bonds of a solvent molecule. The O value of the solvent represents a sum of O values of various substituents or bonds of the solvent molecule. The sum means a sum of values obtained by multiplying I values or O values of various substituents or bonds by the number (per molecule) of the various substituents or bonds.

Examples or the solvent having an I/O value of 1.0 to 3.0 include:
a sulfoxide having an I/O value of 1.0 to 3.0, such as dimethyl sulfoxide (I/O value: 1.75, boiling point: 189 °C.);
a polyhydric alcohol having an I/O value of 1.0 to 3.0, such as 2,3-butanediol (I/O value: 2.5, boiling point: 177° C., triethylene glycol (I/O value: 2.0, boiling point: 285° C.), polyethylene glycol (I/O value: 2.0, boiling point: 200° C. or higher), trimethylolethane (I/O value: 3.0), diethylene glycol (I/O value: 2.75), dipropylene glycol (I/O value: 1.83), or tripropylene glycol (I/O value: 1.33);
a polyhydric alcohol ether having an I/O value of 1.0 to 3.0, such as ethylene glycol monoacetate (I/O value: 1.75, boiling point: 182° C.), ethylene glycol monomethyl ether (I/O value: 2.0), ethylene glycol monoethyl ether (I/O value: 1.5), ethylene glycol monobutyl ether (I/O value: 1.0), diethylene glycol monomethyl ether (I/O value: 1.4), diethylene glycol monoethyl ether (I/O value: 1.17), or propylene glycol monoethyl ether (I/O value: 1.2); and
a carboxylic acid having an I/O value of 1.0 to 3.0, such as butyric acid (I/O value: 1.875) or isobutyric acid (I/O value: 2.143). The solvents may be used singly or in combination of two or more types thereof.

Among the solvents, a solvent having an I/O value of 2.0 to 3.0 is preferable from a viewpoint of particularly enhancing the swellability of a fiber, and a solvent having an I/O value of 1.0 to 2.0 (preferably 1.0 or more and less than 2.0) is preferable from a viewpoint of particularly enhancing the carrier properly of the disperse dye.

Among the solvents, a sulfoxide, a polyhydric alcohol, and a polyhydric alcohol ether are preferable, and a sulfoxide (particularly dimethyl sulfoxide) is more preferable from a viewpoint of easily swelling a fiber and enhancing color developability.

The boiling point of the solvent is not particularly limited, but is preferably equal to or lower than a transfer temperature, and more preferably lower than the transfer temperature from a viewpoint of making it difficult for the disperse dye incorporated into the fiber to come out of the fiber after transfer textile printing. Note that, when the boiling point is too low, the solvent is excessively volatilized during transfer, and it is difficult to obtain a desired effect. Therefore, the boiling point of the solvent is lower than the transfer temperature preferably by 10 to 25° C., more preferably by 20 to 25° C., and can be, for example, 175 to 190° C.

That is, when the solvent remains in a fabric after transfer textile printing, a fiber tends to remain swollen, and a part of the disperse dye (that has dyed the fiber) moves to a surface of the fiber, which may cause contamination. On the other hand, when the boiling point of the solvent is equal to or lower than the transfer temperature, the solvent can be removed with high efficiency by heat during transfer. Therefore, the movement of the disperse dye after transfer can be reliably suppressed and contamination can be prevented.

The content of the solvent having an I/O value of 1.0 to 3.0 is not particularly limited, but is preferably 5% by mass or more, more preferably 50 to 100% by mass, still more preferably 65 to 100% by mass, and particularly preferably 98 to 100% by mass with respect to the pretreatment liquid. When the content of the solvent is equal to or more than the lower limit value, the carrier property of the disperse dye and the swellability of the fiber are more easily enhanced. When the content is equal to or less than the upper limit value, the friction fastness is unlikely to be unpaired.

1-2. Other Component

The pretreatment liquid may further contain a component other than those described above. Examples of the other component include a solvent other than the above solvents, water, a surfactant, a preservative, and a pH adjuster.

(Other Solvent)

The pretreatment liquid may further contain a solvent other than those described above from a viewpoint of adjusting a surface tension and a boiling point as long as the effects according to an embodiment of the present invention are not impaired. The other solvent is a solvent having an I/O value of less than 1.0 or more than 3.0. The solvent is preferably a water-soluble organic solvent.

Examples of such a solvent include an alcohol (for example, methanol, ethanol, propanol, pentanol, hexanol, cyclohexanol, ar benzyl alcohol), a polyhydric alcohol (for example, ethylene glycol, propylene glycol, or polypropylene glycol), and a polyhydric alcohol ether (for example, ethylene glycol monoethyl ether, ethylene glycol monophenyl ether, diethylene glycol monobutyl ether, diethylene glycol dimethyl ether, diethylene glycol diethyl ether, or propylene glycol monomethyl ether).

The content of the other solvent is preferably equal to or less than the content of the solvent having an I/O value of 1.0 to 3.0, although the content of the other solvent depends on an I/O value thereof.

Specifically, when a solvent having an I/O value of less than 1.0 is contained as the other solvent, a content ratio (mass ratio) of the solvent having an I/O value of less than 1.0:the solvent having an I/O value of 1.0 to 3.0 can be 1:1 to 1:99. When a solvent having an I/O value of more than 3.0 is contained as the other solvent, a content ratio (mass ratio) of the solvent having an I/O value of more than 3.0:the solvent hawing an I/O value of 1.0 to 3.0 can be 35:65 to 1:99.

(Surfactant)

The pretreatment liquid preferably further contains a surfactant from a viewpoint of reducing a surface tension and easily enhancing permeability into a fabric and a fiber. The surfactant may be any of a nonionic surfactant, an anionic surfactant, a cationic surfactant, and a betaine-based (amphoteric) surfactant, but when an ink component contains an anionic compound, the surfactant is preferably an anionic surfactant, a nonionic surfactant, or a betaine-based surfactant.

Examples of such a surfactant include a fluorine-based surfactant, a silicone-based surfactant, a sulfate (anionic surfactant) such as dioctyl sulfosuccinate or sodium dodecyl sulfate, polyoxyethylene alkyl ether, polyoxyethylene alkyl phenyl ether, an acetylene glycol, an oxyethylene adduct of acetylene glycol, a Pluronic-based surfactant (Pluronic is a registered trademark), and a nonionic surfactant such as a sorbitan derivative.

Among the surfactants, a fluorine-based surfactant or a silicone-based surfactant is more preferable from a viewpoint of easily reducing the surface tension of the pretreatment liquid and easily enhancing the permeability.

The fluorine-based surfactant is a surfactant having a perfluoroalkyl group or a perfluoroalkenyl group in a molecule thereof, and examples thereof include perfluoroalkyl carboxylate, perfluoroalkyl sulfonate, and oxyethylene perfluoroalkyl ether. Examples of a commercially available product thereof include PolyFOX PF-136A, PF-156A, PF-151N, PF-154, PF-159 (manufactured by Omnova), and UNIDYNE DSN-403N (manufactured by Daikin Industries, Ltd.).

The silicone-based surfactant is a surfactant having a polysiloxane structure in a molecule thereof, and examples thereof include a polysiloxane oxyethylene adduct (polyether-modified organosiloxane). Examples of a commercially available product thereof include BYK-306, BYK-307, BYK-333, BYK-341, BYK -345, BYK-346, and BYK-348 (trade name, manufactured by BYK), and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade name, manufactured by Shin-Etsu Chemical Co., Ltd.),

The content of the surfactant only needs to be in such a range that the surface tension of the pretreatment liquid falls within the above range, and can be, for example, 0.05 to 2% by mass, and preferably 0.5 to 1% by mass with respect to the pretreatment liquid.

(Preservative)

Examples of the preservative include an aromatic halogen compound (for example, Preventol CMK), methylene dithiocyanate, a halogen-containing nitrogen sulfur compound, and 1,2-benzisothiazolin-3-one (for example, PROXEL GXL).

(pH Adjuster)

Examples of the pH adjuster include citric acid, sodium citrate, hydrochloric acid, and sodium hydroxide.

1-3. Physical Properties

The surface tension of the pretreatment liquid at 25° C. is less than 38 mN/m. By setting the surface tension of the pretreatment liquid to less than 38 mN/m, even a pretreatment liquid containing a solvent having an I/O value of 1.0 to 3.0 can favorably permeate a fabric constituted by a natural fiber, a synthetic cellulose fiber, or the like, or a fiber thereof. As a result, a disperse dye can easily enter the fiber, and the amount of the disperse dye remaining on a surface of the fiber can be reduced. Therefore, the friction fastness can be further enhanced while the color developing density is Farther enhanced. The surface tension of the pretreatment liquid is preferably 35 mN/m or less, more preferably 30 mN/m or less, and still more preferably 28 mN/m or less from a similar viewpoint. A lower limit value of the surface tension is preferably 25 mN/m or more from a viewpoint of making it difficult to reduce a surface color density.

The surface tension of the pretreatment liquid can be measured at 25° C. by a Wilhelmy method in accordance with JIS K2241 using a surface tensiometer.

The surface tension of the pretreatment liquid can be adjusted by the type and content of the solvent having an I/O value of 1.0 to 3.0, a content ratio between the solvent and another solvent, the type and content of a surfactant, and the like. For example, when the content of the solvent having an I/O value of 1.0 to 3.0 is increased or the content of the surfactant is increased, the surface tension tends to be lowered.

2. Image Forming Method

An image forming method according to an embodiment of the present invention includes: 1) a step of applying a pretreatment liquid to a fabric containing a natural fiber or a synthetic cellulose fiber (pretreatment step); and 2) a step or transferring an ink layer containing a disperse dye to the fabric to which the pretreatment liquid has been applied (transfer textile printing step).

1) Pretreatment Step

First, the pretreatment liquid according to an embodiment of the present invention is applied to at least a part of a surface of a fabric. Asa result, a pretreated fabric is obtained.

<Fabric>

The fabric contains a natural fiber or a synthetic cellulose fiber. Examples of the natural fiber include cotton, hemp, wool, and silk. Among the fibers, cotton and a synthetic cellulose fiber are preferable.

The fabric may contain two or more types of natural fibers, or may contain a natural fiber or a synthetic cellulose fiber and another fiber. Examples of the other fiber include a chemical fiber such as rayon, vinylon, nylon, acrylic, polyurethane, polyester, or acetate.

A ratio of the natural fiber or the synthetic cellulose fiber can be preferably 35% by mass or more, more preferably 50% by mass or more, and still more preferably 60% by mass or more with respect to fibers constituting the fabric. For example, when the fabric contains a cellulose fiber and a polyester fiber, a ratio of the cellulose fiber can be 35 to 100% by mass, and a ratio of the polyester fibers can be 75 to 0% by mass.

The fabric may be obtained by forming these fibers into any of a woven fabric, a nonwoven fabric, a knitted fabric, and the like.

<Application of Pretreatment Liquid>

The pretreatment liquid is applied to at least a part of a surface of the fabric. The pretreatment liquid may be applied to the entire surface of the fabric or selectively applied only to a region to be dyed.

A method for applying the pretreatment liquid is not particularly limited, and may be any of a spray method, a mangle method (pad method or dipping method), a coating method, and an inkjet method. For example, in the image forming method described later, an inkjet method is preferable from a viewpoint of being able to apply the pretreatment liquid continuously with an ink applying step, and a mangle method or a coater method is preferable from a viewpoint of applying a predetermined amount of the pretreatment liquid in a short time.

In the mangle method, the fabric is immersed in a pretreatment liquid stored in a bath, and then squeezed to adjust the application amount of the pretreatment liquid. The temperature of the pretreatment liquid is not particularly limited, but can be 15 to 30° C. Conditions in the inkjet method can be similar to those in application of ink in a dyeing step.

The application amount it the pretreatment liquid is not particularly limited, and can be adjusted depending on the composition of the pretreatment liquid and the amount of a disperse dye that dyes the fabric. For example, the application amount of the pretreatment liquid is set to 20 to 100% by mass, preferably 30 to 80% by mass with respect to the untreated fabric. When the application amount of the pretreatment liquid is within the above range, in the transfer textile printing step, the carrier property of the disperse dye into the fiber of the fabric is favorable, and the disperse dye can easily permeate the fiber. Note that the application amount of the pretreatment liquid is also referred to as a pickup ratio in the mangle method.

In particular, the application amount of the solvent having an I/O value of 1.0 to 3.0 is set to 10 to 100% by mass, preferably 20 to 80% by mass with respect to the untreated fabric.

Note that the fabric may be dried as long as at least a part of the solvent of the pretreatment liquid applied onto the fabric remains. A drying method can be, for example, heating and drying using hot air, a hot plate, a heat roller, or the like. Note that, in the transfer textile printing step described later, it is preferable not to perform drying from a viewpoint of not impairing the effect of improving the carrier property of the disperse dye in the fabric.

2) Transfer Textile Printing Step

Next, an ink layer containing a disperse dye (transfer image) is transferred to the fabric to which the pretreatment liquid has been applied. Specifically, the transfer image formed on a transfer medium is thermally transferred (transferred by sublimation) to the pretreated fabric.

The thermal transfer is preferably performed before the pretreatment liquid applied to the fabric is completely dried, that is, in a state where the solvent remains on the fabric. Specifically, the thermal transfer is preferably performed in a state where the application amount of the pretreatment liquid is preferably 20% by mass or more with respect to the untreated fabric, in particular, in a state where the application amount of the solvent having an I/O value of 1.0 to 3.0 is preferably maintained at 10% by mass or more with respect to the untreated fabric. As a result, a state where the fiber of the fabric is swollen is maintained, and the solvent functions as a carder of the transferred disperse dye. Therefore, the disperse dye easily enters the fiber, and the color developing density can be enhanced.

The transfer image used is an ink layer containing a disperse dye, formed on a transfer medium. Such a transfer image can be obtained by applying an ink containing a disperse dye onto a transfer medium by, for example, an inkjet method and then drying the ink. The composition of the ink will be described in detail later.

The transfer medium is not particularly limited as long as the ink layer can be formed on a surface of the transfer medium, and the ink layer can be transferred to a fabric, for example, as long as the transfer medium does not interfere with sublimation of a sublimation dye during transfer. The transfer medium is preferably, for example, paper in which an ink-receiving layer is formed by inorganic fine particles such as silica on a surface thereof, and examples thereof include dedicated paper for inkjet and transfer paper.

Next, a surface of the transfer image on the transfer medium is brought into contact with a surface (pretreatment surface) of the fabric to which the pretreatment liquid has been applied, hot pressing is performed, and transfer is performed. As a result, the disperse dye (sublimation dye) in the transfer image on the transfer medium is transferred by sublimation to the fabric to which the pretreatment liquid has been applied to perform dyeing. As a result, a desired image is formed on the fabric.

A transfer temperature (hot pressing temperature) is preferably equal to or higher than the boiling point of the solvent contained in the pretreatment liquid, and can be, for example, 180 to 210° C.

In addition, a pressing pressure is preferably 200 to 500 g/cm² in a case of a flat type and 2 to 6 kg/cm² in a case of a continuous type. In addition, pressing time depends on the temperature, but is preferably 30 seconds to 180 seconds.

As described above, the boiling point of the solvent contained in the pretreatment liquid is preferably lower than the transfer temperature. As a result, a part of the solvent is volatilized by heat during transfer. Therefore, a state where a large amount of the solvent remains after dyeing is unlikely to occur. As a result, since the fiber is less likely to remain swollen, it is possible to suppress the disperse dye that has dyed the fiber from coming out of the fiber. Therefore, contamination due to the disperse dye that has come out of the fiber can be suppressed without performing post-treatment (application of a resin solution, a crosslinking agent, or the like) after the transfer textile printing step.

The image forming method according to an embodiment of the present invention may further include another step as necessary. Note that it is preferable not to perform a step of washing the fabric after the transer textile printing (fabric to which the ink layer containing the disperse dye has been transferred) from a viewpoint of preventing the disperse dye that has dyed the fiber from corning out of the fiber.

3. Ink

The ink used for forming a transfer image contains a disperse dye and water.

<Disperse Dye>

The disperse dye is a dye insoluble or poorly soluble in water. Bing insoluble or poorly soluble in water means that solubility in water at 25° C. is 10 mg/L or less, preferably 5 mg/L or less, and more preferably 1 mg/L, or less, The disperse dye is preferably a sublimation dye that sublimes by heating.

The type of disperse dye is not particularly limited, and can be an azo-based dye, an anthraquinone-based dye, or the like. Among the types of disperse dye, examples of the sublimation dye include the following.

C. I. Disperse Yellow 3, 4, 5, 7, 9, 13, 24, 30, 33, 34, 42, 44, 49, 50, 51, 54, 56, 58, 60, 63, 64, 66, 68, 71, 74, 76, 79, 82, 83, 85, 86, 88, 90, 91, 93, 98, 99, 100, 104, 114, 116, 118, 119, 122, 124, 126, 135, 140, 141, 149, 160, 162, 163, 164, 165, 179, 180, 182, 183, 186, 192, 198, 199, 202, 204, 210, 211, 215, 216, 218, 224, and the like,

C.I. Disperse Orange 1, 3, 5, 7, 11, 13, 17, 20, 21, 25, 29, 30, 31, 32, 33, 37, 35, 42, 43, 44, 45, 47, 45, 49, 50, 53, 54, 55, 56, 57, 58, 59, 61, 66, 71, 73, 76, 78, 80, 89, 90, 91, 93, 96, 97, 119, 127, 130, 139, 142, and the like,

C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 289, 298, 302, 303, 310, 311, 312, 320, 324, 328, and the like,

C. I. Disperse Violet 1, 4, 8, 23, 26, 27, 28, 31, 33, 35, 36, 38, 40, 43, 46, 48, 50, 51, 52, 56, 57, 59, 61, 63, 69, 77, and the like,

C.I. Disperse Green 9 and the like,

C. I. Disperse Brown 1, 2, 4, 9, 13, 19, and the like,

C. I. Disperse Blue 3, 7, 9, 14, 16, 19, 20, 26, 27, 35, 43, 44, 54, 55, 56, 58, 60, 62, 64, 71, 72, 73, 75, 79, 81, 82, 83, 87, 91, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333, 359, 360, and the like, and

C.I. Disperse Black 1, 3, 10, 24, and the like.

As described above, the I/O value of the disperse dye is around 1.0.

The molecular weight of the disperse dye is not particularly limited. However, for example, when an image is formed (sublimation textile printing) by transferring an ink applied onto a transfer medium to a fabric, the molecular weight is preferably small (for example, 200 to 350) from a viewpoint of facilitating sublimation of the disperse dye. On the other hand, the molecular weight is preferably appropriately large (for example, 350 to 500) from a viewpoint of making it difficult for the disperse dye that has permeated the fabric to come out of the fabric.

The disperse dye contained in the ink may be crystallized, or does not have to be crystallized. A method for applying the ink to the transfer medium is not particularly limited, but can be, for example, an inkjet method from a viewpoint of being able to form a highly accurate image.

The average particle size of the disperse dye in the ink is not particularly limited, but can be, for example, 300 nm or less from a viewpoint of injection stability by the inkjet method. The average particle size can be determined by a commercially available particle size measuring device using a light scattering method, an electrophoresis method, a laser Doppler method, or the like, and examples of the particle size measuring device include Zetasizer 1000 manufactured by Malvern Instruments Ltd.

The content of the disperse dye in the ink is not particularly limited, but is preferably 2 to 10% by mass with respect to the ink. When the content of the disperse dye is 2% by mass or more, a high concentration image is easily formed. When the content of the disperse dye is 10% by mass or less, the viscosity of the ink does not become too high, and therefore the injection stability is unlikely to be impaired. The content of the disperse dye is more preferably 5 to 10% by mass with respect to the ink from a similar viewpoint.

<Solvent>

The ink may further contain a solvent as necessary. The solvent is not particularly limited, but is preferably a water-soluble organic solvent. As the water-soluble organic solvent, a water-soluble organic solvent similar to that used for the pretreatment liquid can be used.

In particular, the solvent contained in the ink preferably contains the same solvent as the solvent having an I/O value of 1.0 to 3.0 contained in the pretreatment liquid or a solvent having an I/O value close thereto. As such a solvent, a solvent similar to those exemplified as the solvent having an I/O value of 1.0 to 3.0 can be used. Alternatively, the ink is preferably unlikely to be thickened by drying, and preferably contains a high-boiling point solvent having a boiling point of 200° C. or higher from a viewpoint of making the injection stability in the inkjet method unlikely to be impaired

The high-boiling point solvent having a boiling point of 200° C. or higher only needs to be a water-soluble organic solvent having a boiling point of 200° C. or higher, and is preferably a polyol or a polyalkylene oxide. Examples of the polyol having a boiling point of 200° C. or higher include: a dihydric alcohol such as 1,3 butanediol (boiling point: 208° C.), 1,6 hexanediol (boiling point: 223° C.), or polypropylene glycol; and a trihydric or higher alcohol such as glycerin (boiling point: 290° C.) or trimethylolpropane (boiling point: 295° C.). Examples of the polyalkylene oxide having a boiling point of 200° C. or higher include a dihydric alcohol ether such as diethylene glycol monoethyl ether (boiling point: 202° C.), triethylene glycol monomethyl ether (boiling point: 245° C.), tetraethylene glycol monomethyl ether (boiling point: 305° C.), tripropylene glycol monoethyl ether (boiling point: 256° C.), or polypropylene glycol; and a trihydric or higher alcohol ether such as glycerin (boiling point: 290° C.) or hexanetriol.

The content of the water-soluble organic solvent is preferably 20 to 70% by mass with respect to the ink. When the content of the water-soluble organic solvent is 20% by mass or more with respect to the ink, the dispersibility and the injectability of the disperse dye are easily enhanced. When the content is 70% by mass or less, the drying property of the ink is unlikely to be impaired. In addition, the total content of water and the water-soluble organic solvent is preferably 90 to 98% by mass, and more preferably 90 to 95% by mass with respect to the ink.

<Other Component>

The ink can further contain another component as necessary. Examples of the other component include a dispersant, a surfactant, a preservative, and a pH adjuster.

The dispersant can be selected depending on the type of disperse dye. Examples of the dispersant include a formalin condensate of sodium creosote oil sulfonate, a formalin condensate of sodium cresol sulfonate and sodium 2-naphthol-6-sulfonate, a formalin condensate of sodium cresol sulfonate, a formalin condensate of sodium phenol sulfonate, a formalin condensate of sodium β-naphthol sulfonate, a formalin condensate containing sodium β-naphthalene sulfonate and sodium β-naphthol sulfonate, an alkylene oxide containing ethylene oxide and propylene oxide, an alkylatable compound containing a fatty alcohol, a fatty amine, a fatty acid, a phenol, an alkylphenol, and a carboxylic acid amine, lignin sulfonate, sodium paraffin sulfonate, a copolymer of an α-olefin and maleic anhydride, and a known comb-shaped block polymer.

Examples of the comb-shaped block polymer include DISPERBYK-190, DISPERBYK-194N, DISPERBYK-2010, DISPERBYK-2015, and BYK-154 (“DISPERBYK” and “BYK” are registered trademarks of BYK) manufactured by BYK.

The content of the dispersant is not particularly limited, but is preferably 20 to 200 parts by mass with respect to 100 parts by mass of the disperse dye. When the content of the dispersant is 20 parts by mass or more, the dispersibility of the disperse dye is more easily enhanced. When the content is 200 parts by mass or less, a decrease in injectability due to the dispersant is easily suppressed.

As the surfactant, the preservative, and the pH adjuster, those similar to the surfactant, the preservative, and the pH adjuster that can be used for the pretreatment liquid can be used.

<Physical Properties of Ink >

The viscosity of the ink at 2520 C. is not particularly limited as long as the injectability by the inkjet method is favorable, but is preferably 3 to 20 mPa·s, and more preferably 4 to 12 mPa·s. The viscosity of the ink can be measured by an E-type viscometer at 25° C.

### EXAMPLES

Hereinafter, the present invention will be described with reference to Examples. The scope of the present invention is not construed as being limited by Examples.

1. Preparation of Pretreatment Liquid

<Solvent>

Dimethyl sulfoxide (I/O value: 1.75, boiling point: 189° C.)

2,3-Butanediol (I/O value: 2.5, boiling point: 177° C.)

Diethylene glycol diethyl ether (I/O value: 0.38, boiling point: 188° C.)

Ethylene glycol monoacetate (I/O value: 1.75, boiling point: 182° C.)

Triethylene glycol (I/O value: 2.0, boiling point: 285° C.)

Polyethylene glycol (I/O value: 2.0, boiling point: higher than 200° C.)

Polypropylene glycol (I/O value: 3.3, boiling point: higher than 200° C.)

3-Methoxybutyl acetate (I/O value: 0.57, boiling point: 171° C.)

Ethylene glycol (I/O value: 5.0, boiling point: 197° C.)

As described above, the I/O value was determined by calculating an I value and an O value of each solvent by the methods described in Organic conceptual diagram (written by Yoshio Koda, Sankyo Publishing (1984)); KUMAMOTO PHARMACEUTICAL BULLETIN, No. 1, Sections 1 to 16 (1954); and Chemical domain, Volume 11, No. 10, Sections 719 to 725 (1957), and obtaining a ratio therebetween.

<Surfactant>

E1010: Acetylene-based surfactant (Nissin Chemical Industry Co., Ltd.)

KF-351 A: Silicone-based surfactant (Shin-Etsu Chemical Co., Ltd.)

PF-159: Fluorine-based surfactant (BASF Japan Ltd.)

AsahiGuard AG-E550D: Fluorine-based water-repellent finishing agent (Meisei Chemical Ltd.)

<Preparation or Pretreatment Liquids 1 to 20>

A solvent, a surfactant, and deionized water were mixed so as to have compositions presented in following Tables 1 and 2 to prepare pretreatment liquids 1 to 20.

<Measurement of Surface Tension>

The surface tension of the pretreatment liquid was measured at 25° C. in accordance with JIS K2241 using a Wilhelmy surface tensiometer manufactured by Kyowa Interface Science Co., Ltd.

The compositions and the like of pretreatment liquids 1 to 10 are presented in Table 1. The compositions and the like of pretreatment liquids 11 to 20 are presented in Table 2.

TABLE 1

| | | | Boiling | | | | | | |
|---|---|---|---|---|---|---|---|---|---|
| | | I/O | point | | Pretreatment | Pretreatment | Pretreatment | Pretreatment | Pretreatment |
| | | value | (° C.) | Unit | liquid 1 | liquid 2 | liquid 3 | liquid 4 | liquid 5 |
| Solvent | Dimethyl | 1.75 | 189 | % by | 99.95 | 99.5 | 99 | 3 | 5 |
| | sulfoxide | | | mass | | | | | |
| | 2,3-Butanediol | 2.50 | 177 | | | | | | |
| | Diethylene | 0.38 | 188 | | | | | | |
| | glycol diethyl | | | | | | | | |
| | ether | | | | | | | | |
| | Ethylene glycol | 1.75 | 182 | | | | | | |
| | monoacetate | | | | | | | | |
| | Triethylene | 2.00 | 285 | | | | | | |
| | glycol | | | | | | | | |
| | Polyethylene | 2.00 | Higher | | | | | | |
| | glycol | | than | | | | | | |
| | | | 200° C. | | | | | | |
| | Polypropylene | 3.30 | Higher | | | | | | |
| | glycol | | than | | | | | | |
| | | | 200° C. | | | | | | |
| | 3-Methoxybutyl | 0.57 | 171 | | | | | | |
| | acetate | | | | | | | | |
| | Ethylene glycol | 5.00 | 197 | | | | | | |
| Surfactant | E 1010 (acetylene-based | | | | | | | | |
| | surfactant) | | | | | | | | |
| | KF-351 A (silicone-based | | | | 0.05 | 0.5 | 1 | 2 | 2 |
| | surfactant) | | | | | | | | |
| | PF-159 (fluorine-based | | | | | | | | |
| | surfactant) | | | | | | | | |
| | AG-E550D (fluorine-based | | | | | | | | |
| | water-repellent agent) | | | | | | | | |
| Deionized water | | | | | | | | 95 | 93 |
| Total | | | | % by | 100 | 100 | 100 | 100 | 100 |
| | | | | mass | | | | | |
| Content, of solvent having | | | | % by | 99.95 | 99.5 | 99 | 3 | 5 |
| I/O value of 1 to 3 | | | | mass | | | | | |
| Surface tension | | | | mN/m | 35 | 30 | 28 | 38 | 37 |
| Note | | | | | Example | Example | Example | Example | Example |
| | | | Boiling | | | | | | |
| | | I/O | point | | Pretreatment | Pretreatment | Pretreatment | Pretreatment | Pretreatment |
| | | value | (° C.) | Unit | liquid 6 | liquid 7 | liquid 8 | liquid 9 | liquid 10 |
| Solvent | Dimethyl | 1.75 | 189 | % by | 98 | 99 | 10 | 50 | 69 |
| | sulfoxide | | | mass | | | | | |
| | 2,3-Butanediol | 2.50 | 177 | | | | 90 | | |
| | Diethylene | 0.38 | 188 | | | | | 50 | |
| | glycol diethyl | | | | | | | | |
| | ether | | | | | | | | |
| | Ethylene glycol | 1.75 | 182 | | | | | | |
| | monoacetate | | | | | | | | |
| | Triethylene | 2.00 | 285 | | | | | | |
| | glycol | | | | | | | | |
| | Polyethylene | 2.00 | Higher | | | | | | |
| | glycol | | than | | | | | | |
| | | | 200° C. | | | | | | |
| | Polypropylene | 3.30 | Higher | | | | | | |
| | glycol | | than | | | | | | |
| | | | 200° C. | | | | | | |
| | 3-Methoxybutyl | 0.57 | 171 | | | | | | |
| | acetate | | | | | | | | |
| | Ethylene glycol | 5.00 | 197 | | | | | | 30 |

| | | | | |
|---|---|---|---|---|
| Surfactant | E 1010 (acetylene-based | 2 | | |
| | surfactant) | | | |
| | KF-351 A (silicone-based | | | 1 |
| | surfactant) | | | |
| | PF-159 (fluorine-based | | 1 | |
| | surfactant) | | | |
| | AG-E550D (fluorine-based | | | |
| | water-repellent agent) | | | |

| | | | | | | |
|---|---|---|---|---|---|---|
| Deionized water | | | | | | |
| Total | % by | 100 | 100 | 100 | 100 | 100 |
| | mass | | | | | |
| Content, of solvent having | % by | 98 | 99 | 100 | 50 | 69 |
| I/O value of 1 to 3 | mass | | | | | |
| Surface tension | mN/m | 37 | 27 | 37 | 35 | 37 |

| | | | | | |
|---|---|---|---|---|---|
| Note | Example | Example | Example | Example | Example |

TABLE 2

| | | | Boiling | | | | | | |
|---|---|---|---|---|---|---|---|---|---|
| | | I/O | point | | Pretreatment | Pretreatment | Pretreatment | Pretreatment | Pretreatment |
| | | value | (° C.) | Unit | liquid 11 | liquid 22 | liquid 13 | liquid 14 | liquid 15 |
| Solvent | Dimethyl | 1.75 | 189 | % by | 100 | | | | |
| | sulfoxide | | | mass | | | | | |
| | 2,3-Butanediol | 2.50 | 177 | | | | | | |
| | Diethylene | 0.38 | 188 | | | | | | |
| | giycol diethyl | | | | | | | | |
| | ether | | | | | | | | |
| | Ethylene glycol | 1.75 | 182 | | | | | 15 | |
| | monoacetate | | | | | | | | |
| | Triethylene | 2.00 | 285 | | | | | 15 | |
| | glycol | | | | | | | | |
| | Polyethylene | 2.00 | Higher | | | 10 | | | |
| | glycol | | than | | | | | | |
| | | | 200° C. | | | | | | |
| | Polypropylene | 3.30 | Higher | | | | 30 | | 3.5 |
| | glycol | | than | | | | | | |
| | | | 200° C. | | | | | | |
| | 3-Methoxybutyl | 0.57 | 171 | | | | | | |
| | acetate | | | | | | | | |
| | Ethylene glycol | 5.00 | 197 | | | | | | |
| Surfactant | E 1010 (acetylene-based | | | | | | | | |
| | surfactant) | | | | | | | | |
| | KF-351 A (silicone-based | | | | | | | | |
| | surfactant) | | | | | | | | |
| | PF-159 (fluorine-based | | | | | | | | |
| | surfactant) | | | | | | | | |
| | AG-E550D (fluorine-based | | | | | | | | 4.5 |
| | water-repellent agent) | | | | | | | | |
| Deionized water | | | | | | 90 | 70 | 70 | 92 |
| Total | | | | % by | 100 | 100 | 100 | 100 | 100 |
| | | | | mass | | | | | |
| Content of solvent having | | | | % by | 100 | 10 | 0 | 30 | 0 |
| I/O value of 1 to 3 | | | | mass | | | | | |
| Surface tension | | | | mN/m | 43 | 47 | 46 | 38.1 | 30 |
| Note | | | | | Comparative | Comparative | Comparative | Comparative | Comparative |
| | | | | | Example | Example | Example | Example | Example |
| | | | Boiling | | | | | | |
| | | I/O | point | | Pretreatment | Pretreatment | Pretreatment | Pretreatment | Pretreatment |
| | | value | (° C.) | Unit | liquid 16 | liquid 17 | liquid 18 | liquid 19 | liquid 20 |
| Solvent | Dimethyl | 1.75 | 189 | % by | | | | | |
| | sulfoxide | | | mass | | | | | |
| | 2,3-Butanediol | 2.50 | 177 | | | | | | |
| | Diethylene | 0.38 | 188 | | | | | | |
| | giycol diethyl | | | | | | | | |
| | ether | | | | | | | | |
| | Ethylene glycol | 1.75 | 182 | | | | | | 99 |
| | monoacetate | | | | | | | | |
| | Triethylene | 2.00 | 285 | | | 99 | | | |
| | glycol | | | | | | | | |
| | Polyethylene | 2.00 | Higher | | | | | | |
| | glycol | | than | | | | | | |
| | | | 200° C. | | | | | | |
| | Polypropylene | 3.30 | Higher | | | | | | |
| | glycol | | than | | | | | | |
| | | | 200° C. | | | | | | |
| | 3-Methoxybutyl | 0.57 | 171 | | | | 100 | | |
| | acetate | | | | | | | | |
| | Ethylene glycol | 5.00 | 197 | | 100 | | | 99 | |

| | | | | |
|---|---|---|---|---|
| Surfactant | E 1010 (acetylene-based | | | |
| | surfactant) | | | |
| | KF-351 A (silicone-based | 1 | 1 | 1 |
| | surfactant) | | | |
| | PF-159 (fluorine-based | | | |
| | surfactant) | | | |
| | AG-E550D (fluorine-based | | | |
| | water-repellent agent) | | | |

| | | | | | | |
|---|---|---|---|---|---|---|
| Deionized water | | | | | | |
| Total | % by | 100 | 100 | 100 | 100 | 100 |
| | mass | | | | | |
| Content of solvent having | % by | 0 | 99 | 0 | 0 | 99 |
| I/O value of 1 to 3 | mass | | | | | |
| Surface tension | mN/m | 48 | 30 | 28 | 35 | 30 |

| | | | | | |
|---|---|---|---|---|---|
| Note | Comparative | Example | Comparative | Comparative | Example |
| | Example | | Example | Example | |

2. Image Formation and Evaluation

[Image Formation]

<Tests 1 to 21>

(1) Pretreatment

As a fabric, cotton broad 40 (cotton 100%, I/O value: 2.95) was used. The fabric was immersed in a bath filled with the prepared pretreatment liquid, and then the excess pretreatment liquid was removed by squeezing the fabric with a mangle roll at a pickup ratio of 80%. The temperature of the pretreatment liquid in the bath was 20 to 25° C.

(2) Application of Ink to Transfer Paper

Next, an inkjet printer having an inkjet head (Konica Minolta head KM1024iMAE) was prepared as an image forming apparatus. Then, TexStylus Black manufactured by System Graphics Co., Ltd., which is an ink, was discharged from a nozzle of the inkjet head to form a solid image on A4 sublimation transfer paper with glue (manufactured by System Graphics Co., Ltd.) as transfer paper. Note that the ink is an ink containing a sublimation dye (I/O value: 0.5 to 1.1) as a disperse dye.

Specifically, an image (200 mm×200 mm in total) including a thin line grid, a gradation, and a solid portion was formed at 540 dpi in main scanning×720 dpi in sub scanning. The dpi represents the number of ink droplets (dots) per 2.54 cm. A discharge frequency was 22.4 kHz. Thereafter, the transfer paper to which the ink had been applied was dried at 50 to 80° C. for 30 seconds with a dryer.

(3) Transfer of Ink to Fabric

Next, the transfer paper to which the ink (ink layer) had been applied was thermocompression-bonded to the fabric in a state where a solvent of the pretreatment liquid remained (pickup ratio: about 80%) at 200° C. for 50 seconds at a press pressure of 300 g/cm² using a transfer device (heat press machine). As a result, the ink on the transfer paper was transferred onto the pretreated fabric to obtain an image-formed product.

<Evaluation>

A color developing density and friction fastness (wet friction and dry friction) of each of the image-formed products obtained in tests 1 to 21 were evaluated by the following method.

(Image Density)

An image density was measured by a spectrocolorimeter (manufactured by X-Rite Inc.), and a K/S value was calculated. The K/S value is an index of a surface color density defined by the following formula.

K/S=(1−R)²/2S Kubelka-Munk formula:

(K: light absorption coefficient, S: light scattering coefficient, R: surface reflectance)

The larger the K/S value, the higher the color density. The smaller the K/S value, the lower the color density.

5: K/S value is 16 or more

4: K/S value is 14 or more and less than 16.

3: K/S value is 12 or more and less than 14.

2: K/S value is 10 or more and less than 12.

1: K/S value is less than 10

(Dry/Wet Friction Fastness)

The obtained image-formed products were evaluated for dry friction fastness and wet friction fastness by a clock meter (friction tester type 1) in accordance with HS L 0849. Using a gray scale for contamination based on JIS 0805 as an evaluation cloth, a grade was determined and evaluated by the following indices.

5: Grade is 4 or more

4: Grade is 3.5 or less

3: Grade is 3 or less

2: Grade is 2.5 or less

1: Grade is 2 or less

Evaluation results of tests 1 to 21 are presented in Table 3.

TABLE 3

| | | Solvent | | | | | | | | | |
|---|---|---|---|---|---|---|---|---|---|---|---|
| | | | | | | Content of | Surface | | | | |
| | | Solvent 1 | | Solvent 2 | | solvent having | tension of | Evaluation | | | |
| | | | Boiling | | Boiling | I/O value | pretreatment | | Dry | Wet | |
| Test | Pretreatment | I/O | point | I/O | point | of 1 to 3 | liquid | Color | friction | friction | |
| No. | liquid No. | value | (° C.) | value | (° C.) | (% by mass) | (mN/m) | developability | fastness | fastness | Note |
| 1 | 4 | 1.75 | 189 | — | — | 3 | 38 | 3 | 3 | 2 | Example |
| 2 | 5 | 1.75 | 189 | — | — | 5 | 37 | 3 | 3 | 2 | Example |
| 3 | 6 | 1.75 | 189 | — | — | 98 | 37 | 4 | 4 | 3 | Example |
| 4 | 10 | 1.75 | 189 | 5.0 | 197 | 69 | 37 | 4 | 3 | 2 | Example |
| 5 | 8 | 2.50 | 177 | 1.75 | 189 | 100 | 37 | 4 | 4 | 3 | Example |
| 6 | 9 | 0.38 | 188 | 1.75 | 189 | 50 | 35 | 3 | 4 | 3 | Example |
| 7 | 7 | 1.75 | 189 | — | — | 99 | 27 | 5 | 5 | 4 | Example |
| 8 | 1 | 1.75 | 189 | — | — | 99.95 | 35 | 4 | 4 | 3 | Example |
| 9 | 2 | 1.75 | 189 | — | — | 99.5 | 30 | 5 | 5 | 4 | Example |
| 10 | 3 | 1.75 | 189 | — | — | 99 | 28 | 5 | 5 | 4 | Example |
| 11 | 17 | 2.00 | 285 | — | — | 99 | 30 | 3 | 3 | 2 | Example |
| 12 | 20 | 1.75 | 182 | — | — | 99 | 30 | 2 | 5 | 4 | Example |
| 13 | None | — | — | — | — | — | — | 1 | 5 | 5 | Comparative |
| | | | | | | | | | | | Example |
| 14 | 11 | 1.75 | 189 | — | — | 100 | 43 | 4 | 2 | 1 | Comparative |
| | | | | | | | | | | | Example |
| 15 | 12 | 2.00 | 200< | — | — | 10 | 47 | 1 | 2 | 1 | Comparative |
| | | | | | | | | | | | Example |
| 16 | 13 | 3.30 | 200< | — | — | 0 | 46 | 1 | 1 | 1 | Comparative |
| | | | | | | | | | | | Example |
| 17 | 14 | 1.75 | 182 | 2.0 | 285 | 30 | 38.1 | 1 | 2 | 2 | Comparative |
| | | | | | | | | | | | Example |
| 18 | 15 | 3.30 | 200< | — | — | 0 | 30 | 1 | 2 | 1 | Comparative |
| | | | | | | | | | | | Example |
| 19 | 16 | 5.00 | 197 | — | — | 0 | 48 | 2 | 1 | 1 | Comparative |
| | | | | | | | | | | | Example |
| 20 | 18 | 0.57 | 171 | — | — | 0 | 28 | 1 | 5 | 5 | Comparative |
| | | | | | | | | | | | Example |
| 21 | 19 | 5.00 | 197 | — | — | 0 | 35 | 3 | 2 | 1 | Comparative |
| | | | | | | | | | | | Example |

As presented in Table 3, in tests 1 to 12 using pretreatment liquids 1 to 10, 17, and 20 each containing a solvent having, an I/O value of 1.0 to 3.0 and having a surface tension of less than 38 mN/m, it is found that an image-formed product having a high color developing density and high friction fastness can be obtained.

On the other hand, in tests 14 to 17 using pretreatment liquids 11 to 14 each containing a solvent having an I/O value of 1.0 to 3.0 but having a surface tension of 38 mN/m or more (Comparative Examples), it is found that friction fastness is particularly low. This is considered to be because the pretreatment liquid did not sufficiently permeate the fabric or fiber, and therefore the disperse dye could not enter the fabric or fiber during transfer textile printing and remained on a surface of the fiber.

In addition, in test 13 in which no pretreatment was performed (Comparative Example), it is found that color developability is low. In addition, it is found that friction fastness is evaluated to be 5 because the dye that has not been used for dyeing remains on a transfer base material side without being transferred.

In addition, in tests 15 and 16 in which pretreatment was performed (Comparative Examples), both color developability and friction fastness are low. A reason for this is presumed as follows. That is, polyethylene glycol and polypropylene glycol each have a large molecular weight, and are therefore unlikely to permeate the fiber. In addition, these solvents have substantially no boiling point, and are therefore likely to remain as a dyeable layer (dyeable region) on a surface of the fiber as they are even after transfer. Therefore, the disperse dye dyes an inside of the dyeable layer on a surface of the fiber more than the inside of the fiber. In the friction fastness test, since the dyeable layer itself is peeled off when being rubbed, it is considered that the friction fastness is lowered.

In addition, in tests 18 and 19 using pretreatment liquids 15 and 16 containing no solvent having an I/O value of 1.0 to 3.0 (Comparative Examples), it is found that both the color developing density and the friction fastness are low. In particular, since pretreatment liquid 15 contains less solvent and more water, it is considered that the color developabillity is low in test 18 using pretreatment liquid 15.

In addition, in test 20 using pretreatment liquid 18 containing only a solvent having an I/O value of less than 1.0, it is found that the color developability is low. In test 21 using pretreatment liquid 19 containing only a solvent having an I/O value of more than 3.0, it is found that the friction fastness is low.

In addition, in test 10 using pretreatment liquid 3 using DMSO, it is found that the color developability is better than that in test 12 using pretreatment liquid 20 using ethylene glycol monoacetate.

According to an embodiment of the present invention, it is possible to provide a pretreatment liquid and an image forming method capable of forming an image having a high color developing density and friction fastness even on a fabric containing a hydrophilic fiber such as a natural fiber.

Although embodiments of the present invention have been described and illustrated in detail, the disclosed embodiments are made for purposes of illustration and example only and not limitation. The scope of the present invention should he interpreted by terms of the appended claims.

What is claimed is:

1. A pretreatment liquid for a fabric used for transfer textile printing, the pretreatment liquid comprising a solvent having an organic/inorganic value (I/O value) of 1.0 to 3.0, and having a surface tension of less than 38 mN/m at 25° C.

2. The pretreatment liquid according to claim 1, wherein
the solvent contains one or more selected from the group consisting of a sulfoxide, a polyhydric alcohol, and a polyhydric alcohol ether each having an I/O value of 1.0 to 3.0.

3. The pretreatment liquid according to claim 2, wherein the solvent contains a sulfoxide having an I/O value of 1.0 to 3.0.

4. The pretreatment liquid according to claim 1, wherein
a boiling point of the solvent is equal to or lower than a transfer temperature.

5. The pretreatment liquid according to claim 1, wherein
a content of the solvent is 5% by mass or more with respect to the pretreatment liquid.

6. The pretreatment liquid according to claim 1, wherein
the pretreatment liquid further contains a surfactant.

7. The pretreatment liquid according to claim 1, wherein
the surface tension is 28 mN/m or less.

8. An image forming method comprising:
applying the pretreatment liquid according to claim 1 to a fabric containing a natural fiber or a synthetic cellulose fiber; and
transferring an ink layer containing a disperse dye onto the fabric to which the pretreatment liquid has been applied.

9. The image forming method according to claim 8, wherein
the fabric contains cotton or a synthetic cellulose fiber.

10. The image forming method according to claim 8, not comprising washing the fabric to which the ink layer containing the disperse dye has been transferred.
